(19) United States
(12) Patent Application Publication
(10) Pub. No.: US 2026/0273932 A1
(43) Pub. Date: Sep. 17, 2026

(54) LIQUID EJECTING APPARATUS AND DRIVING METHOD THEREOF

(71) Applicant: SEIKO EPSON CORPORATION, Tokyo (JP)

(72) Inventors: Mitsuki EBISAWA, SHIOJIRI-SHI (JP); Takanori AIMONO, SHIOJIRI-SHI (JP); Takahiro KATAKURA, OKAYA-SHI (JP)

(21) Appl. No.: 19/567,667

(22) Filed: Mar. 16, 2026

(30) Foreign Application Priority Data
Mar. 17, 2025 (JP) 2025-042146

(51) Int. Cl. B41J 2/045; B41J 2/14

(52) U.S. Cl. CPC B41J 2/04588; B41J 2/04541; B41J 2/04581; B41J 2/14233

(57) ABSTRACT

A liquid ejecting apparatus comprises a discharge portion that includes a nozzle, and a pressure chamber communicating with the nozzle, and a piezoelectric element displaced to cause a pressure fluctuation in liquid in the pressure chamber according to a supplied drive signal. The drive signal has a first discharge pulse comprises a first contraction element to contract the pressure chamber and a first damping element to expand the pressure chamber. The first contraction element changes the potential to cause the liquid to protrude from the nozzle. The first damping element starts changing the potential within a period commencing at a start of the first contraction element and being greater than or equal to (N+0.75) times and less than or equal to (N+1.25) times a natural vibration period of the discharge portion (N is a natural number greater than or equal to 1).

The present application is based on, and claims priority from JP Application Serial Number 2025-042146, filed Mar. 17, 2025, the disclosure of which is hereby incorporated by reference herein in its entirety.

### BACKGROUND

### 1. Technical Field

The present disclosure relates to a liquid ejecting apparatus including a discharge portion that discharges liquid from a nozzle and a driving method thereof, and particularly to an ink jet recording apparatus including the discharge portion that ejects ink as a liquid and a driving method thereof.

### 2. Related Art

A liquid ejecting apparatus, which is represented by an ink jet recording apparatus such as an ink jet printer or a plotter, includes a discharge portion configured to eject liquid, such as ink, stored in a cartridge, a tank, or the like, as droplets.

The discharge portion includes a nozzle that ejects liquid, a pressure chamber that communicates with the nozzle, and a drive element that causes a pressure fluctuation in the liquid in the pressure chamber, and discharges droplets from the nozzle by supplying a drive signal represented by a drive waveform to the drive element (for example, see JP-A-2000-263775).

However, when a piezoelectric element is driven to expand the pressure chamber at a point in time when the Helmholtz resonance cycle of the pressure chamber elapsed from a point in time when the drive signal for driving the piezoelectric element is started to cause the pressure chamber to contract and discharge the droplets from the nozzle, there is a problem in that a speed of a satellite droplet generated when the droplets are discharged from the nozzle is low, the satellite droplet floats before landing on a print medium, and there is a possibility that the print quality deteriorates.

### SUMMARY

According to an aspect of the present disclosure, there is provided a liquid ejecting apparatus including a discharge portion that includes a nozzle discharging liquid, a pressure chamber communicating with the nozzle, and a piezoelectric element displaced to cause a pressure fluctuation in the liquid in the pressure chamber according to a supplied drive signal, and a drive circuit that generates the drive signal, in which the drive signal has a first discharge pulse that changes a potential to cause a droplet to be discharged from the nozzle, and the first discharge pulse has a first contraction element that changes the potential to cause the pressure chamber to contract and changes the potential to cause the liquid to protrude from the nozzle, and a first damping element that starts changing the potential to be greater than or equal to (N+0.75) times and less than or equal to (N+1.25) times a natural vibration period of the discharge portion (Nis a natural number greater than or equal to 1) from a start of the first contraction element to expand the pressure chamber.

According to another aspect of the present disclosure, there is provided a driving method of a liquid ejecting apparatus including a discharge portion that includes a nozzle discharging liquid, a pressure chamber communicating with the nozzle, and a piezoelectric element displaced to cause a pressure fluctuation in the liquid in the pressure chamber according to a supplied drive signal, and a drive circuit that generates the drive signal, the method including supplying the drive signal which has a first discharge pulse having a first contraction element that changes a potential to cause the pressure chamber to contract and changes the potential to cause the liquid to protrude from the nozzle, and a first damping element that starts changing the potential to be greater than or equal to (N+0.75) times and less than or equal to (N+1.25) times a natural vibration period of the discharge portion (N is a natural number greater than or equal to 1) from a start of the first contraction element to expand the pressure chamber, to the piezoelectric element to cause a droplet to be discharged from the nozzle.

### BRIEF DESCRIPTION OF THE DRAWINGS

FIG. 1 is a view illustrating a schematic configuration of a liquid ejecting apparatus according to Embodiment 1.

FIG. 2 is a cross-sectional view of a discharge portion according to Embodiment 1.

FIG. 3 is a block diagram illustrating an electrical configuration of the liquid ejecting apparatus according to Embodiment 1.

FIG. 4 is a graph illustrating a drive waveform of a drive signal and a pressure change according to Embodiment 1.

FIG. 5 is a cross-sectional view of a vicinity of a nozzle when a droplet is discharged according to Embodiment 1.

FIG. 6 is a cross-sectional view of the vicinity of the nozzle when the droplet is discharged according to Embodiment 1.

FIG. 7 is a cross-sectional view of the vicinity of the nozzle when the droplet is discharged according to Embodiment 1.

FIG. 8 is a cross-sectional view of the vicinity of the nozzle when the droplet is discharged according to Embodiment 1.

FIG. 9 is a graph illustrating a drive waveform illustrating a drive signal and pressure vibration of a comparative example.

FIG. 10 is a view illustrating a flight state of a droplet by a discharge pulse of the comparative example.

FIG. 11 is a view illustrating a flight state of a droplet by a first discharge pulse.

FIG. 12 is a table showing a relationship between time t1 And a speed of a satellite droplet.

FIG. 13 is a graph illustrating a drive waveform illustrating a drive signal and a pressure change of Modification example 1.

FIG. 14 is a graph illustrating the drive waveform illustrating the drive signal of Modification example 1.

FIG. 15 is a graph illustrating a drive waveform illustrating a drive signal and a pressure change of Modification example 2.

FIG. 16 is a graph illustrating a drive waveform illustrating a modification example of the drive signal of Modification example 2.

FIG. 17 is a graph illustrating a drive waveform illustrating a drive signal of Modification example 3.

FIG. 18 is a graph illustrating a drive waveform illustrating a drive signal of Embodiment 2.

FIG. 19 is a graph illustrating a drive waveform illustrating a drive signal of Embodiment 3.

### DESCRIPTION OF EMBODIMENTS

The present disclosure will be described in detail below based on embodiments. However, the following description shows one aspect of the present disclosure, and can be modified as desired within the scope of the present disclosure. In each drawing, the same reference numerals indicate the same members, and the description thereof will be omitted as appropriate. Further, in each figure, X, Y, and Z represent three spatial axes that are orthogonal to each other. In the present specification, the directions along these axes are the X direction, the Y direction, and the Z direction. The direction in which the arrow in each figure points is the positive (+) direction, and the opposite direction of the arrow is the negative (−) direction. Further, the Z direction indicates a vertical direction, the +Z direction indicates a vertically downward direction, and the −Z direction indicates a vertically upward direction. Furthermore, directions along the three spatial axes of which the positive direction and the negative direction are not limited will be referred to as an X-axis direction, a Y-axis direction, and a Z-axis direction.

### Embodiment 1

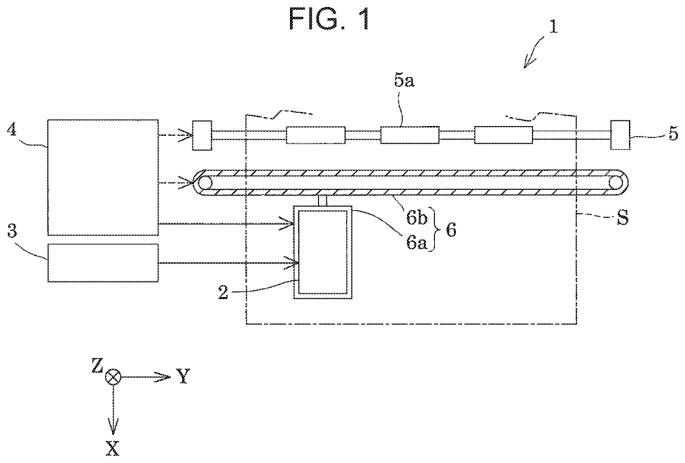

FIG. 1 is a view illustrating a schematic configuration of a liquid ejecting apparatus 1 according to the present disclosure.

As illustrated in the drawing, the liquid ejecting apparatus 1 is a so-called serial printer that includes a discharge portion 2 and performs printing by transporting a medium S in the X-axis direction as the discharge portion 2 is reciprocated in the Y-axis direction, and discharging (also called ejecting) ink, which is an example of liquid, from the discharge portion 2 toward the medium S in the +Z direction. For the medium S, any material such as recording paper, resin film, or cloth can be used.

The liquid ejecting apparatus 1 includes a discharge portion 2, a liquid storage portion 3, a control portion 4, a transport mechanism 5 that sends out the medium S, and a moving mechanism 6.

The discharge portion 2 discharges the ink supplied from the liquid storage portion 3 as ink droplets in the +Z direction.

The liquid storage portion 3 stores the ink to be ejected from the discharge portion 2. Examples of the liquid storage portion 3 include a cartridge detachable from the liquid ejecting apparatus 1, a bag-shaped ink pack formed of a flexible film, and an ink tank that can be replenished with ink. Although not particularly illustrated in the drawings, for example, a plurality of types of ink with different colors and components are individually stored in the liquid storage portion 3. Further, the liquid storage portion 3 may be divided into a main tank and a sub tank. A sub-tank may be coupled to the discharge portion 2, and the ink consumed by ejecting droplets from the discharge portion 2 may be replenished from the main tank to the sub-tank. Further, the ink may be circulated between the liquid storage portion 3 and the discharge portion 2.

The control portion 4 includes, for example, a control device such as a central processing unit (CPU) or a field programmable gate array (FPGA), and a storage device such as a semiconductor memory. Further, the control portion 4 also includes a power supply device that supplies power supplied from an external power supply such as a commercial power supply to each element of the liquid ejecting apparatus 1. The control portion 4 is electrically coupled to the discharge portion 2 via an external wiring (not illustrated). The control portion 4 comprehensively controls each element of the liquid ejecting apparatus 1 by the control device executing a program stored in the storage device.

The transport mechanism 5 transports the medium S in the X-axis direction, and has, for example, a transport roller 5a that rotates by a transport motor controlled and driven by the control portion 4.

The moving mechanism 6 is a mechanism for reciprocating the discharge portion 2 in the Y-axis direction, and includes a holder 6a that holds the discharge portion 2 and a transport belt 6b that is an endless belt erected along the Y-axis direction. The control portion 4 rotates the transport belt 6b by controlling the drive of a transport motor (not illustrated), thereby reciprocating the discharge portion 2 in the Y-axis direction together with the holder 6a fixed to the transport belt 6b.

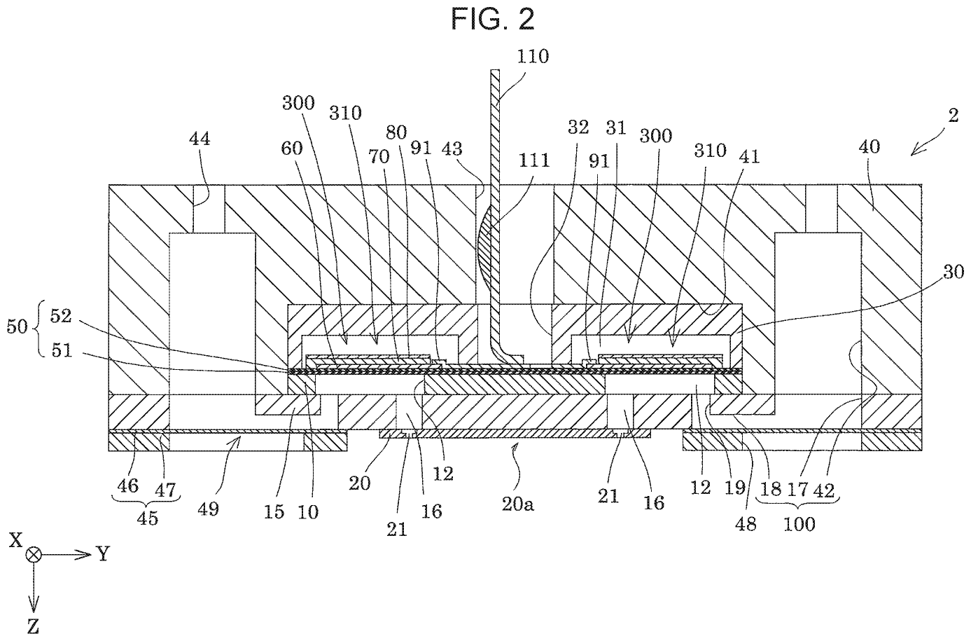

Under the control of the control portion 4, the discharge portion 2 executes an ejection operation of ejecting ink supplied from the liquid storage portion 3 as droplets from each of a plurality of nozzles 21 (see FIG. 2) in the +Z direction. The ejection operation by the discharge portion 2 is performed in parallel with the transportation of the medium S by the transport mechanism 5 and the reciprocating movement of the discharge portion 2 by the moving mechanism 6, so that so-called printing in which the ink is applied to the medium S is performed.

FIG. 2 is a cross-sectional view of the discharge portion 2 according to one embodiment of the present disclosure. Each direction of the discharge portion 2 will be described based on the directions when the discharge portion 2 is mounted, that is, the X-axis direction, the Y-axis direction, and the Z-axis direction.

As illustrated in the drawing, the discharge portion 2 of the present embodiment includes a pressure chamber substrate 10, a communication plate 15, a nozzle plate 20 on which the plurality of nozzles 21 are formed, a protective substrate 30, a case member 40, a piezoelectric element 300, and a wiring member 110.

The pressure chamber substrate 10 is made of, for example, a silicon substrate. In the pressure chamber substrate 10, a plurality of pressure chambers 12 are arranged side by side along the X-axis direction. The plurality of pressure chambers 12 are arranged side by side along the X-axis direction to be at the same position in the Y-axis direction. The two pressure chambers 12 adjacent to each other in the X-axis direction are partitioned by a partition wall (not illustrated). Further, in the present embodiment, two pressure chamber rows, in which the pressure chambers 12 are disposed side by side along the X-axis direction, are provided in the Y-axis direction.

The communication plate 15 and the nozzle plate 20 are sequentially stacked on the surface of the pressure chamber substrate 10 facing the +Z direction. A vibration plate 50 and the piezoelectric element 300 are sequentially stacked on the surface of the pressure chamber substrate 10 facing the −Z direction.

The communication plate 15 is made of a plate-shaped member joined to a surface of the pressure chamber substrate 10 facing the +Z direction. The communication plate 15 is provided with a nozzle communication path 16 that makes the pressure chamber 12 and the nozzle 21 communicate with each other. Further, the communication plate 15 is provided with a first common liquid chamber portion 17 and a second common liquid chamber portion 18 that constitute a common liquid chamber 100 through which the plurality of pressure chambers 12 communicate in common. The first common liquid chamber portion 17 is provided to penetrate the communication plate 15 in the Z-axis direction. Further, the second common liquid chamber portion 18 is provided to be open on the surface facing the +Z direction without penetrating the communication plate 15 in the Z-axis direction. Furthermore, the communication plate 15 is provided with a supply communication path 19 that communicates with one end portion of the pressure chamber 12 in the Y-axis direction, independently for each pressure chamber 12. The supply communication path 19 causes the second common liquid chamber portion 18 and the pressure chamber 12 to communicate with each other, and supplies the ink in the common liquid chamber 100 to the pressure chamber 12. As such a communication plate 15, a silicon substrate or the like can be used.

The nozzle plate 20 is bonded to the surface of the communication plate 15 facing the +Z direction. The nozzle plate 20 has the nozzles 21 formed therein, which communicate with each of the pressure chambers 12 through the nozzle communication path 16. In the present embodiment, the plurality of nozzles 21 are arranged side by side in a row along the X-axis direction. Further, in the present embodiment, two nozzle rows, in which the nozzles 21 are disposed side by side along the X-axis direction, are provided spaced apart in the Y-axis direction. In the present embodiment, a surface of the nozzle plate 20 facing the +Z direction, where the nozzles 21 open is referred to as a nozzle surface 20a.

The material of the nozzle plate 20 is not particularly limited, and for example, a silicon substrate or the like can be used.

The vibration plate 50 has, for example, an elastic film 51 made of silicon oxide provided on a side of the pressure chamber substrate 10, and an insulator film 52 made of zirconium oxide disposed on the surface of the elastic film 51 facing the −Z direction.

The piezoelectric element 300 includes a first electrode 60 sequentially stacked on the vibration plate 50 in the −Z direction, a piezoelectric layer 70 constructed using a piezoelectric material made of a composite oxide having a perovskite structure represented by, for example, a general formula ABO₃, and a second electrode 80. The piezoelectric element 300 is also referred to as a piezoelectric actuator, and refers to a part including the first electrode 60, the piezoelectric layer 70, and the second electrode 80. Further, a part where piezoelectric strain occurs in the piezoelectric layer 70 when a voltage is applied between the first electrode 60 and the second electrode 80 is referred to as an active portion 310. Meanwhile, a part where piezoelectric strain does not occur in the piezoelectric layer 70 is referred to as an inactive portion. That is, the active portion 310 refers to a part where the piezoelectric layer 70 is interposed between the first electrode 60 and the second electrode 80. In the present embodiment, the active portion 310 is formed for each pressure chamber 12. That is, a plurality of active portions 310 are formed in the piezoelectric element 300. The plurality of active portions 310 serve as drive elements that cause a pressure change in the ink in the pressure chamber 12. In general, one of the electrodes of the active portion 310 is configured as an independent individual electrode for each active portion 310, and the other electrode is configured as a common electrode common to the plurality of active portions 310. In the present embodiment, the first electrode 60 configures an individual electrode, and the second electrode 80 configures a common electrode.

Further, a lead electrode 91, which is a lead wiring, is drawn from each electrode of the piezoelectric element 300. A wiring member 110 formed of a flexible substrate having flexibility is coupled to the end portion of the lead electrode 91 on the side opposite to the end portion coupled to the piezoelectric element 300. The wiring member 110 is mounted with a drive circuit 111 having a plurality of switching elements that select whether or not to supply a drive signal for driving each of the active portions 310 to each of the active portions 310. In other words, the wiring member 110 in the present embodiment is a chip-on-film (COF). The wiring member 110 may not be provided with the drive circuit 111. In other words, the wiring member 110 may be a flexible flat cable (FFC), a flexible printed circuit (FPC), or the like.

The protective substrate 30 having substantially the same size as the pressure chamber substrate 10 is joined to the surface of the pressure chamber substrate 10 facing the −Z direction. The protective substrate 30 has an accommodation portion 31 which is a space for protecting the piezoelectric element 300. The accommodation portions 31 are provided independently for each row of the piezoelectric elements 300 disposed side by side in the X-axis direction, and the two accommodation portions 31 are formed to be arranged in the Y-axis direction. Further, a through hole 32 penetrating in the Z-axis direction is provided between the two accommodation portions 31 arranged side by side in the Y-axis direction, in the protective substrate 30. The end portion of the lead electrode 91 drawn from each electrode of the piezoelectric element 300 extends to be exposed in the through hole 32, and the lead electrode 91 and the wiring member 110 are electrically coupled to each other in the through hole 32. Such a protective substrate 30 is made of, for example, a silicon substrate.

Further, the case member 40 that defines the common liquid chamber 100 that communicates with the plurality of pressure chambers 12 is fixed onto the protective substrate 30. The case member 40 has substantially the same shape as the communication plate 15 described above in plan view, and is bonded to the protective substrate 30 and also bonded to the communication plate 15 described above.

The case member 40 has a recessed portion 41 having a depth for accommodating the pressure chamber substrate 10 and the protective substrate 30 on a side of the protective substrate 30. The recessed portion 41 has an opening area wider than the surface of the protective substrate 30 joined to the pressure chamber substrate 10. With the pressure chamber substrate 10 and the protective substrate 30 accommodated in the recessed portion 41, the opening surface of the recessed portion 41 on a side of the nozzle plate 20 is sealed by the communication plate 15.

Further, the case member 40 is also provided with a third common liquid chamber portion 42 that communicates with the first common liquid chamber portion 17 of the communication plate 15. The first common liquid chamber portion 17 and the second common liquid chamber portion 18 provided in the communication plate 15 and the third common liquid chamber portion 42 provided in the case member 40 constitute the common liquid chamber 100 of the present embodiment. The common liquid chambers 100 are provided for each row of the pressure chambers 12, that is, two common liquid chambers in total. Each of the common liquid chambers 100 is provided continuously along the X-axis direction in which the pressure chambers 12 are arranged side by side, and the supply communication paths 19 that communicate each of the pressure chambers 12 with the common liquid chamber 100 are arranged side by side in the X-axis direction. Further, the case member 40 is provided with an introduction port 44 that communicates with the common liquid chamber 100 and supplies ink to each of the common liquid chambers 100. Further, the case member 40 is also provided with a coupling port 43 that communicates with the through hole 32 of the protective substrate 30 and through which the wiring member 110 is inserted. As such a material of the case member 40, a metal material, a resin material, or the like is used.

Further, a compliance substrate 45 is provided on the surface of the communication plate 15 on the +Z direction side where the first common liquid chamber portion 17 and the second common liquid chamber portion 18 open. The compliance substrate 45 seals the openings of the first common liquid chamber portion 17 and the second common liquid chamber portion 18 on the ejection surface side. In the present embodiment, such a compliance substrate 45 includes a sealing film 46 made of a flexible thin film, and a fixed substrate 47 made of a hard material such as metal. The area of the fixed substrate 47 facing the common liquid chamber 100 is an opening portion 48 that is completely removed in the thickness direction, so that one side of the common liquid chamber 100 forms a compliance portion 49, which is a flexible portion sealed only by the flexible sealing film 46.

Such a discharge portion 2 takes in ink from the liquid storage portion 3 through the introduction port 44 into the common liquid chamber 100, filling the interior from the common liquid chamber 100 to the nozzle 21, and then a voltage is applied to each of the active portions 310 corresponding to the pressure chamber 12 in accordance with a drive signal from the drive circuit 111. As a result, the vibration plate 50 is bent and deformed together with the active portion 310, the pressure of the ink in each of the pressure chambers 12 is increased, and ink droplets are ejected from each of the nozzles 21.

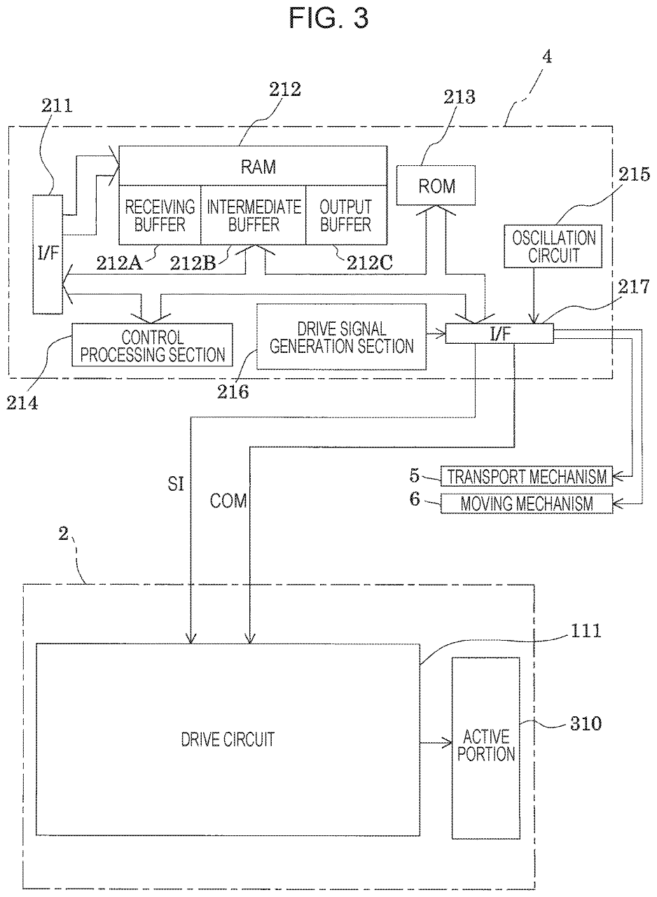

FIG. 3 is a block diagram illustrating an electrical configuration of the liquid ejecting apparatus 1. The control portion 4 is an element that controls the entire liquid ejecting apparatus 1. The control portion 4 includes an external interface 211 (hereinafter referred to as the external I/F 211), a RAM 212 for temporarily storing various types of data, a ROM 213 for storing a control program or the like, a control processing section 214 including a CPU or the like, an oscillation circuit 215 for generating a clock signal (CK), a drive signal generation section 216 for generating a drive signal to be supplied to the discharge portion 2, and an internal interface 217 (hereinafter referred to as the internal I/F 217).

The external I/F 211 is an interface for transmitting and receiving data to and from a host computer (not illustrated) or the like. The data received by the control portion 4 from the host computer via the external I/F 211 includes, for example, print data configured with character codes, graphic functions, image data, or the like. Further, examples of data transmitted by the control portion 4 via the external I/F 211 include a busy signal (BUSY) and an acknowledge signal (ACK). The RAM 212 functions as a receiving buffer 212A, an intermediate buffer 212B, an output buffer 212C, and a work memory (not illustrated). The receiving buffer 212A temporarily stores print data received by the external I/F 211, the intermediate buffer 212B stores intermediate code data converted by the control processing section 214, and the output buffer 212C stores dot pattern data. This dot pattern data is configured with recording data (SI) obtained by decoding (translating) the gradation data.

The drive signal generation section 216 generates a drive signal COM. As will be described in more detail later, the drive signal COM is a signal that has a first discharge pulse DP1 within one unit period T, which drives the active portion 310 to discharge ink droplets from the nozzle 21, and is repeatedly generated for each unit period T. The unit period T is a repeating unit of the drive signal COM and corresponds to one pixel of an image to be printed on the medium S.

The ROM 213 stores font data, graphic functions, or the like in addition to a control program (control routine) for causing the control processing section 214 to perform various types of data processing. The control processing section 214 reads the print data in the receiving buffer 212A and stores intermediate code data obtained by converting the print data in the intermediate buffer 212B. Further, the intermediate code data read from the intermediate buffer 212B is analyzed, and the intermediate code data is expanded into recording data by referring to the font data and graphic functions stored in the ROM 213. Then, the control processing section 214 performs necessary decoration processing and then stores the expanded recording data in the output buffer 212C. The control program may be read from a recording medium such as a floppy disk, a CD-ROM, a DVD-ROM, or a USB memory that is directly coupled via the external I/F 211 or that is coupled via a host computer. Further, the control program may also be provided in the host computer as a printer driver.

During printing, when recording data equivalent to one line of the discharge portion 2 is obtained, the control processing section 214 outputs this one line of recording data to the discharge portion 2 through the internal I/F 217. Further, when one line of recording data is output from the output buffer 212C, the expanded intermediate code data is erased from the intermediate buffer 212B, and the expansion processing is performed on the next intermediate code data.

The discharge portion 2 includes the drive circuit 111. The drive circuit 111 is a circuit that selectively supplies the first discharge pulse DP1 of the drive signal COM to the active portion 310 based on the recording data (SI) sent from the control portion 4 via the internal I/F 217.

The recording data (SI) is configured with a plurality of pieces of pixel data to be discharged for each of a plurality of dots that constitute one line. For example, it is assumed that pixel data is binary, with “1” representing that a dot is to be formed and “0” representing that a dot is not to be formed. When the pixel data is “1”, the drive circuit 111 supplies the first discharge pulse DP1 to the active portion 310, which discharges ink droplets from the nozzle 21 corresponding to the pixel data, and when the pixel data is “0”, the drive circuit 111 does not supply the first discharge pulse DP1 to the active portion 310.

In this manner, under the control of the control portion 4, the discharge portion 2 discharges ink droplets from each of the nozzles 21 at a timing defined by the recording data or the like. The control portion 4 controls the transport mechanism 5 to transport the medium S and the moving mechanism 6 to reciprocate the discharge portion 2 via the internal I/F 217 in parallel with the discharge operation by the discharge portion 2. Printing is performed on the medium S under such control of the control portion 4.

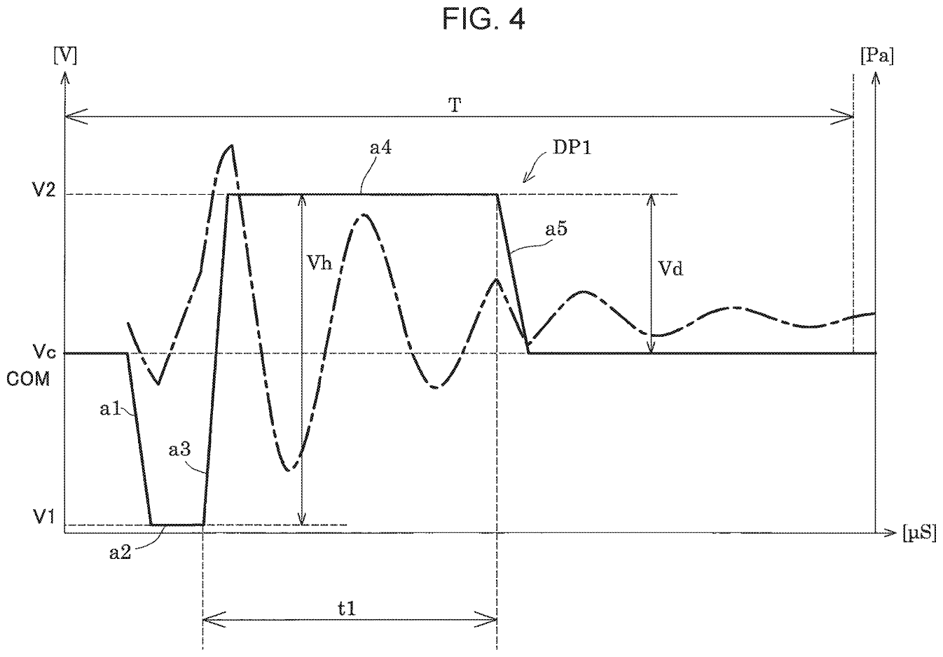

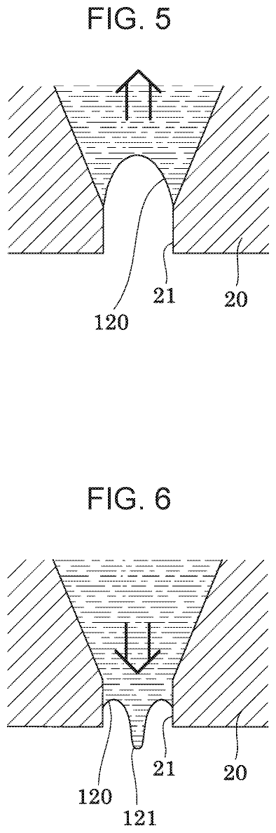

FIG. 4 is a graph illustrating a pressure fluctuation in the pressure chamber 12 when the active portion 310 is driven by the drive waveform indicating the drive signal COM and the first discharge pulse DP1. FIGS. 5 to 8 are cross-sectional views of the vicinity of the nozzle 21 when a droplet is discharged.

As illustrated in FIG. 4, the drive signal COM is repeatedly generated from the drive signal generation section 216 for each unit period T defined by a clock signal transmitted from the oscillation circuit 215. The unit period T corresponds to one pixel of an image or the like to be printed on the medium S. In the present embodiment, the first discharge pulse DP1 is generated in the unit period T.

In the present embodiment, the drive signal COM is supplied to the first electrode 60 that is the individual electrode of the active portion 310. The voltage applied to the active portion 310 is a difference between the potential supplied to the first electrode 60 that is the individual electrode and the potential supplied to the second electrode 80 that is the common electrode.

The first discharge pulse DP1 of the drive signal COM is for causing the plurality of dots divided into a plurality within one unit period T to land on the medium S at a first interval, and continuously includes a first charge element a1, a first charge potential maintenance element a2, a first contraction element a3, a first potential maintenance element a4, and a first damping element a5 are provided in this order in time series.

The volume change of the pressure chamber 12 and the change in a liquid surface 120 of the liquid in the nozzle 21 when each element of the first discharge pulse DP1 is supplied to the active portion 310 will be described below.

The first charge element a1 changes the potential from a reference potential Vc to a first potential V1, thereby expanding the volume of the pressure chamber 12 from a reference volume. As illustrated in FIG. 5, the liquid surface 120 of the ink in the nozzle 21 is pulled to a side of the pressure chamber 12 by the first charge element a1, and the ink is supplied to the pressure chamber 12 from a side of the common liquid chamber 100.

The first charge potential maintenance element a2 maintains the first potential V1, which is the potential of the end point of the first charge element a1, for a certain period of time. Pressure vibration occurs in the ink in the pressure chamber 12 during the supply of the first charge potential maintenance element a2. The period of the pressure vibration of the ink in the pressure chamber 12, so-called, a natural vibration period Tc is also referred to as the Helmholtz vibration period, and can be generally expressed by the following equation (1).

$$Tc = 2 {π [ ( Mn + Ms ) \times ( Cc + C 1 ) / ( Mn \times Ms ) ]}^{\frac{1}{2}} \qquad ( 1 )$$

In the above equation, Mn is the inertance of the nozzle 21 (mass of the ink per unit cross-sectional area), Ms is the inertance of the supply communication path 19, Cc is the compliance of the pressure chamber 12 (volume change per unit pressure, and indicates the degree of softness), and Ci is the compliance of the ink (Ci=volume V/[density ρ×sound speed c2]).

The first contraction element a3 changes the potential from the first potential V1 to a second potential V2, thereby causing the volume of the pressure chamber 12 to contract. As illustrated in FIG. 6, a liquid column 121 starts to protrude in the +Z direction from the liquid surface 120 of the ink in the nozzle 21 by the first contraction element a3.

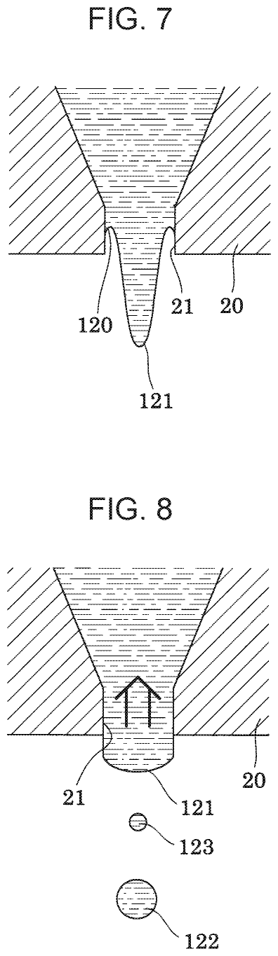

The first potential maintenance element a4 maintains the second potential V2, which is the potential of the end point of the first contraction element a3, for a certain period of time. As illustrated in FIG. 7, the liquid column 121 extends as the first potential maintenance element a4 is supplied, and as illustrated in FIG. 8, the liquid column 121 is separated from the ink in the nozzle 21 before the first damping element a5 starts, and the separated liquid column 121 is further separated into a plurality of droplets. In the present embodiment, the liquid column 121 is separated into two droplets. In the present embodiment, a leading droplet in the +Z direction, which is the ejection direction, is referred to as a main droplet 122, and a trailing droplet is referred to as a satellite droplet 123.

The first damping element a5 changes the potential from the second potential V2 to the reference potential Vc, thereby expanding the volume of the pressure chamber 12. The first damping element a5 suppresses the vibration of the liquid surface 120 in the nozzle 21.

In the present embodiment, time t1 from the start of the first contraction element a3 to the start of the first damping element a5, that is, the time t1 from the start point of the first contraction element a3 to the start point of the first damping element a5, is set to be greater than or equal to (N+0.75) times and less than or equal to (N+1.25) times the natural vibration period Tc of the pressure chamber 12 (N is a natural number greater than or equal to 1). That is, the time t1 satisfies the relationship of (N+0.75)×Tc≤t1≤(N+1.25)×Tc. Further, the time t1 is preferably 1.75 times or greater and 2.25 times or less, and the time t1 is more preferably 2×Tc.

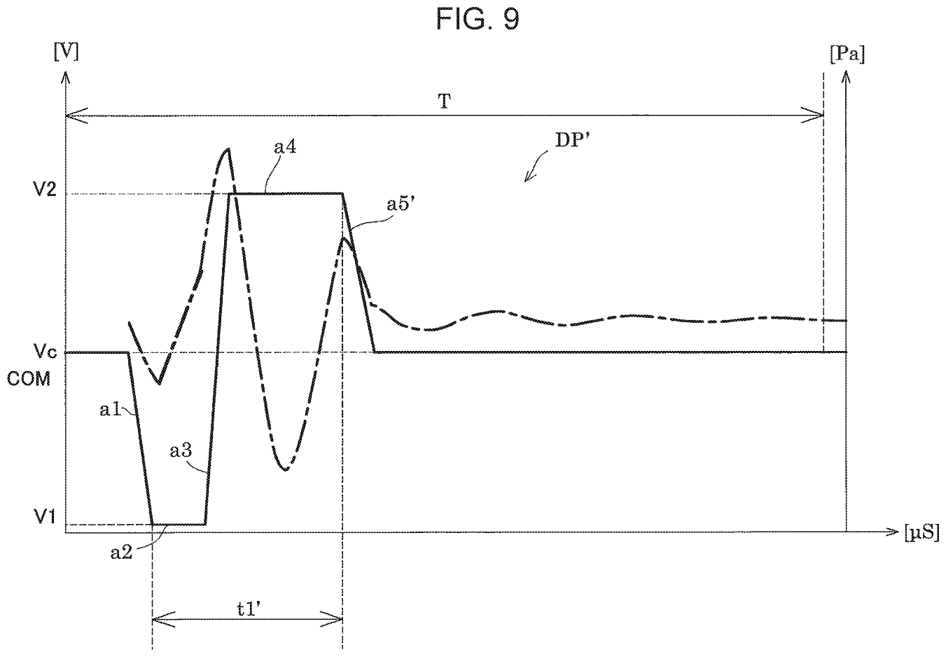

FIG. 9 is a graph illustrating a drive waveform of the drive signal COM including a discharge pulse DP′ of the comparative example and a pressure fluctuation of the ink in the pressure chamber 12 when the active portion 310 is driven by the discharge pulse DP′ of the comparative example, illustrates the drive signal COM by a solid line, and illustrates the pressure fluctuation by a one-dot chain line.

The discharge pulse DP′ of the comparative example is the same as the first discharge pulse DP1 described above except that time t1′ between the start point of the first contraction element a3 and the start point of a first damping element a5′ is 1×Tc.

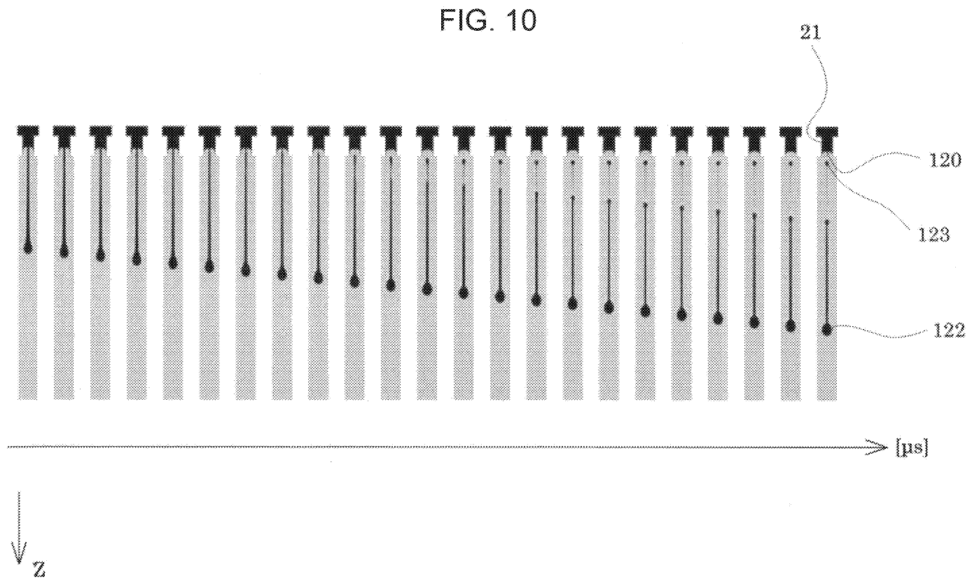

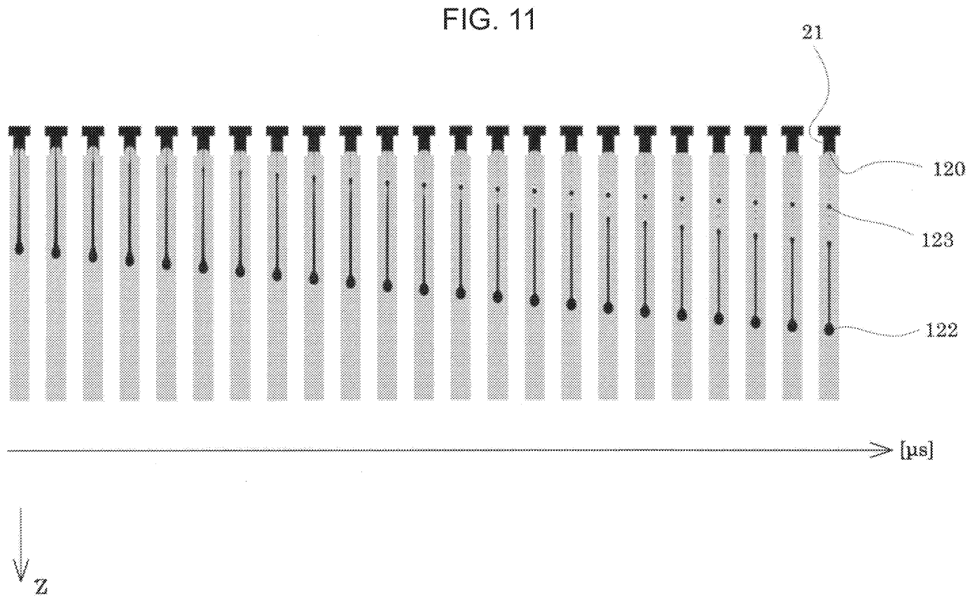

Here, the flight states of the main droplet 122 and the satellite droplet 123 ejected by the first discharge pulse DP1 are illustrated in FIG. 11. Further, FIG. 10 illustrates the flight states of the main droplet 122 and the satellite droplet 123 ejected by the discharge pulse DP′ of the comparative example. FIGS. 10 and 11 are views illustrating simulation results, and illustrate a state where the liquid column 121 is separated into the main droplet 122 and the satellite droplet 123 and flies from the left to the right in the drawing in time series.

As illustrated in FIG. 10, in the time t1 of the comparative example, although the main droplet 122 moves in the +Z direction, the satellite droplet 123 does not move in the +Z direction, and the speed of the satellite droplet 123 is slow. When the first damping element a5 is started from the start of the first contraction element a3 by the time t1 of 1×Tc, in a state where the ink in the nozzle 21 and the liquid column 121 are coupled to each other, the vibration of the liquid surface 120 of the ink in the nozzle 21 by the first contraction element a3 is damped by the first damping element a5 at an early stage. Then, the vibration of the liquid surface 120 is damped at an early stage by the first damping element a5, so that the liquid column 121 is less likely to be separated from the ink in the nozzle 21, and the speed of the satellite droplet 123 is decreased. That is, the speed of the satellite droplet 123 becomes slower as the time for the liquid column 121 to be separated from the ink in the nozzle 21 becomes slower.

When the speed of the satellite droplet 123 is slow as described above, the satellite droplet 123 drifts as mist in the liquid ejecting apparatus 1 and cannot land on the medium S. Therefore, the sufficient ink cannot be landed on the medium S, and the desired dots cannot be formed, so that the printing quality deteriorates.

Meanwhile, as illustrated in FIG. 11, in the time t1 of the present embodiment, as the main droplet 122 moves in the +Z direction, the satellite droplet 123 also moves in the +Z direction. This is because, in a state where the ink in the nozzle 21 and the liquid column 121 are coupled to each other, the larger the vibration of the liquid surface 120 in the nozzle 21, the shorter the time for the liquid column 121 to be separated from the ink in the nozzle 21, and the faster the speed of the satellite droplet 123. By increasing the speed of the satellite droplet 123 in this manner, the satellite droplet 123 does not become mist, and the satellite droplet 123 can be landed on the medium S. As a result, the printing quality can be improved by causing a sufficient amount of ink to land on the medium S to form the target dots.

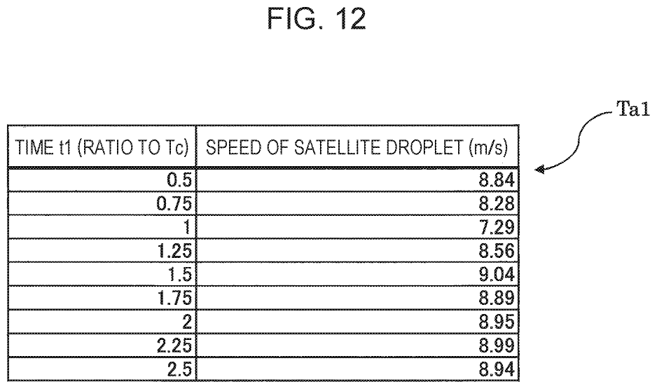

Here, the result of measuring the speed of the satellite droplet 123 when the ink droplet is discharged by changing the time t1 of the first discharge pulse DP1 is shown in Table Tal of FIG. 12. In Table Tal, the time t1 is represented as a ratio to the natural vibration period Tc. Further, the speed of the satellite droplet 123 is a result of measuring the speed of the rear point of the satellite droplet 123 by image processing.

As shown in Table Tal of FIG. 12, when the ratio of the time t1 to the natural vibration period Tc is 1, the speed of the satellite droplet 123 is 7.29, which is the slowest. Further, when the ratio of the time t1 to the natural vibration period Tc is 1.25 or greater, the speed of the satellite droplet 123 is faster than the case of the ratio of 1.

However, when the ratio of the time t1 to the natural vibration period Tc is 1.5 and 2.5, the first damping element a5 is started at the timing when the ink in the discharge portion 2 reaches the most negative pressure due to the residual vibration, so that the negative pressure of the ink in the discharge portion 2 generated by the driving of the active portion 310 by the first damping element a5 excites the vibration of the meniscus of the liquid surface 120 in the nozzle 21. Therefore, the residual vibration after the ink droplet is discharged remains for a long time, the remaining residual vibration affects the discharge of the next ink droplet, the stable discharge of the ink droplet cannot be performed, and the discharge of the continuous ink droplets cannot be performed at a high frequency. Therefore, the time t1 excludes the cases of the ratios 1.5 and 2.5. That is, the time t1 excludes (N+0.5)×Tc (N is a natural number greater than or equal to 1).

For this reason, in order to increase the speed of the satellite droplet 123 and to damp the vibration of the liquid surface 120 in the nozzle 21 by the first damping element a5, the time t1 is greater than or equal to (N+0.75) and less than or equal to (N+1.25) (N is a natural number greater than or equal to 1).

Incidentally, when the time t1 from the start of the first contraction element a3 to the start of the first damping element a5 is too long, the drive period T becomes long, and the continuous ink droplets cannot be discharged at a high frequency. As a result, it is preferable that the time t1 is as short as possible and is at least as long as it takes for the speed of the satellite droplets 123 to increase, and the time t1 is preferably 1.75×Tc or longer and 2.25×Tc or shorter. Further, it is more preferable that the time t1 is 2×Tc. This is because, by setting the time t1 to 2×Tc, the supply of the first damping element a5 can be started at the timing when the ink in the discharge portion 2 reaches the positive pressure due to the residual vibration, the positive pressure of the residual vibration is offset by the negative pressure of the ink in the discharge portion 2 generated by the driving of the active portion 310 by the first damping element a5, and the residual vibration of the liquid surface 120 in the nozzle 21 can be more effectively suppressed.

A potential difference Vd of the first damping element a5 is preferably 10% or greater and 80% or less of a potential difference Vh from the first potential V1 to the second potential V2 of the first contraction element a3. For example, when the potential difference Vd is less than 10% of the potential difference Vh, the force for suppressing the vibration of the liquid surface 120 in the nozzle 21 is weak, and the large residual vibration remains. Further, when the potential difference Vd is greater than 80% of the potential difference Vh, the vibration of the liquid surface 120 in the nozzle 21 is excessively damped, and thus the large residual vibration remains. For example, when the potential difference Vh of the first contraction element a3 is 20 V, the potential difference Vd of the first damping element a5 is 2 V or greater and 16 V or less. Further, when the potential difference Vh is 35 V, the potential difference Vd is 3.5 V or greater and 28 V or less.

Further, the application time of the first damping element a5 is, for example, 1.5 us or greater and 5 μs or less.

Further, the potential change rate of the first damping element a5 is, for example, 4 V/μs or greater and 15 V/μs or less.

As described above, by setting the time t1 from the start of the first contraction element a3 of the first discharge pulse DP1 to the start of the first damping element a5 to be greater than or equal to (N+0.75)×Tc and less than or equal to (N+1.25)×Tc (N is a natural number greater than or equal to 1) with respect to the natural vibration period Tc, the printing quality can be improved by improving the speed of the satellite droplet 123, and the residual vibration caused by the discharge of the ink droplet can be damped, so that the continuous ink droplets can be stably discharged, and the continuous ink droplets can be discharged at a high frequency.

Further, the first discharge pulse DP1 of the present embodiment has the first potential maintenance element a4 that maintains the second potential V2 of the end point of the first contraction element a3 between the end point of the first contraction element a3 and the start point of the first damping element a5. That is, by not driving the active portion 310 between the end point of the first contraction element a3 and the start point of the first damping element a5, the vibration of the liquid column 121 in the direction of being pulled to the side of the pressure chamber 12 is not given. As a result, the residual vibration of the ink in the nozzle 21 is not damped, the residual vibration affects the separation of the ink of the nozzle 21 and the liquid column 121, and by suppressing an increase in the time it takes for the satellite droplet 123 to be separated from the main droplet 122, the decrease in the speed of the satellite droplet 123 can be suppressed.

### Modification Example 1

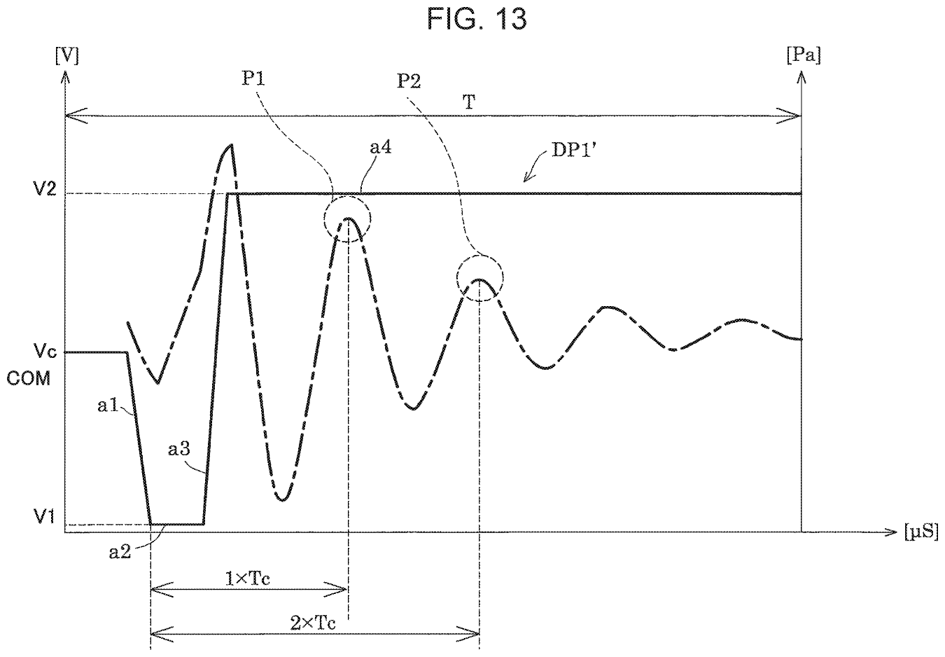

As illustrated in FIG. 13, when the active portion 310 is driven by a first discharge pulse DP1′ from which the first damping element a5 of the first discharge pulse DP1 is removed, the pressure of the ink in the pressure chamber 12 changes as illustrated in a graph of a one-dot chain line in FIG. 13. In FIG. 13, the drive signal COM including the first discharge pulse DP1′ is illustrated by a solid line, and the graph illustrating the pressure fluctuation is illustrated by a one-dot chain line.

In the discharge pulse DP′ of the comparative example in FIG. 9, the first damping element a5 is started at a position P1 in the vicinity of 1×Tc of the graph illustrating the pressure change of the ink in the pressure chamber 12 in FIG. 13, that is, in the vicinity where the pressure of the ink in the pressure chamber 12 reaches the first peak on the positive pressure side. Meanwhile, in the first discharge pulse DP1 of Embodiment 1 in FIG. 4, the first damping element a5 is started at a position P2 in the vicinity of 2×Tc of the graph illustrating the pressure change of the ink in the pressure chamber 12 in FIG. 13, that is, in the vicinity where the pressure of the ink in the pressure chamber 12 reaches the second peak on the positive pressure side. However, since the residual vibration is gradually attenuated, the magnitude of the pressure of the ink in the pressure chamber 12 is different between the position P1 and the position P2. As a result, when the first damping element a5 of the first discharge pulse DP1 at the position P2 is set to the same potential difference and potential change rate per unit time as the first damping element a5′ suitable for damping the residual vibration at the position P1 of the discharge pulse DP′ of the comparative example, the damping pressure with respect to the magnitude of the residual vibration of the ink in the pressure chamber 12 becomes too large. Therefore, as illustrated in FIG. 4, although the first damping element a5 is supplied at the position P2, when the damping pressure with respect to the magnitude of the residual vibration of the ink in the pressure chamber 12 is too large, the effect of suppressing the residual vibration of the ink in the pressure chamber 12 is reduced.

Here, an attenuation ratio ζ of the pressure chamber 12 at the position P2 with respect to the position P1 is obtained from the following equation (2).

$$ζ = {e}^{- \frac{R}{2 L} Tc} \qquad ( 2 )$$

In the equation (2), R is the resistance of the entire flow path and is represented by the resistance coefficient× viscosity. L is the inductance of the entire flow path, and Tc is the natural vibration period.

That is, the expansion amount of the pressure chamber 12 required for the first damping element a5 of the first discharge pulse DP1 may be ζ times the expansion amount of the pressure chamber 12 of the first damping element a5′ of the discharge pulse DP′ of the comparative example, and it can be said that the first damping element a5 of the first discharge pulse DP1 in FIG. 4 is vibrated excessively by (1−ζ) times.

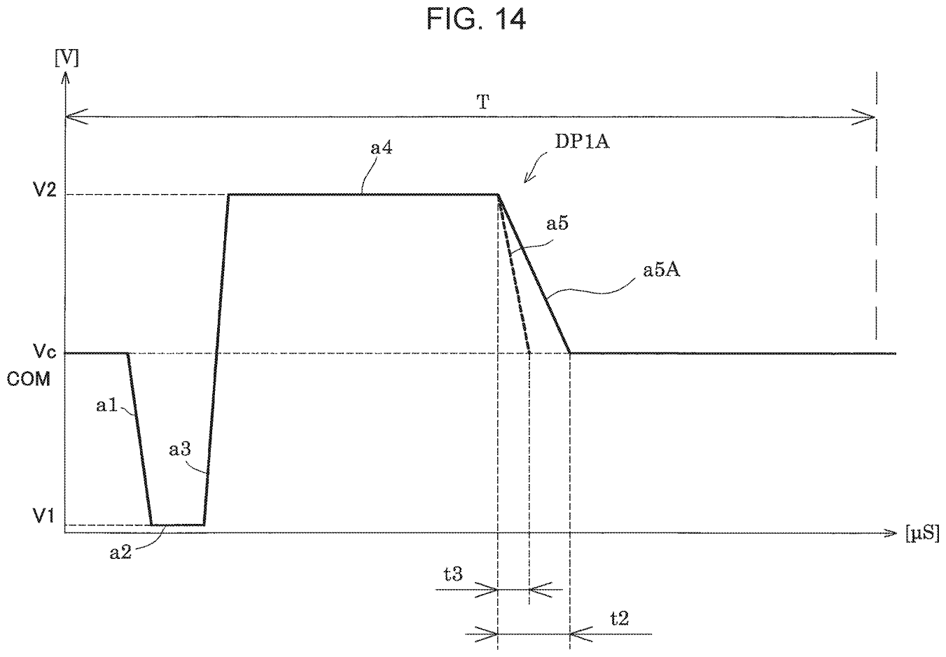

Therefore, as illustrated in FIG. 14, in the present Modification example 1, the potential change rate per unit time of a first damping element a5A of a first discharge pulse DP1A is set to be smaller than that of the first damping element a5 of FIG. 4 and FIG. 9. FIG. 14 is a waveform diagram illustrating the first discharge pulse DP1A of Modification example 1, and the first damping element a5 of FIG. 4 and FIG. 9 is illustrated by a dotted line. Further, the first discharge pulse DPIA has, in place of the first damping element a5, the first damping element a5A having a smaller potential change rate per unit time than that of the first damping element a5.

A potential change rate per unit time SR1 of the first damping element a5A is obtained from an attenuation factor ζ by the following equation (3).

$$SR 1 = SR 2 \times \frac{1}{ζ} = {SR 2 e}^{\frac{R}{2 L} Tc} \qquad ( 3 )$$

In addition, in the equation (3), SR1 is a potential change rate per unit time of the first damping element a5′ of the discharge pulse DP′ of the comparative example or the first damping element a5 of the first discharge pulse DP1.

Incidentally, in the first discharge pulse DP1A, application time t2 of the first damping element a5A is adjusted without changing the potential difference between the second potential V2 and the reference potential Vc of the discharge pulse DP′ of the comparative example or the first discharge pulse DP1. The application time t2 is obtained by the following equation (4).

$$t 2 = \frac{Tb}{ζ} = {t 3 e}^{\frac{R}{2 L} Tc} \qquad ( 4 )$$

In the equation (4), t3 is the application time of the first damping element a5′ or the first damping element a5.

As described above, by making the potential change rate per unit time SR1 of the first damping element a5A relatively smaller than a value suitable for damping at the position P1 based on the attenuation factor ζ of the residual vibration, the residual vibration of the liquid surface 120 can be effectively suppressed without causing the liquid surface 120 in the nozzle 21 after the first damping element a5A is supplied to vibrate excessively. As a result, the residual vibration after the ink droplet is discharged by the first discharge pulse DP1A does not easily affect the discharge of the ink droplet by the next first discharge pulse DP1A, and the discharge of the next ink droplet can be stably performed as the drive period T can be relatively shortened.

### Modification Example 2

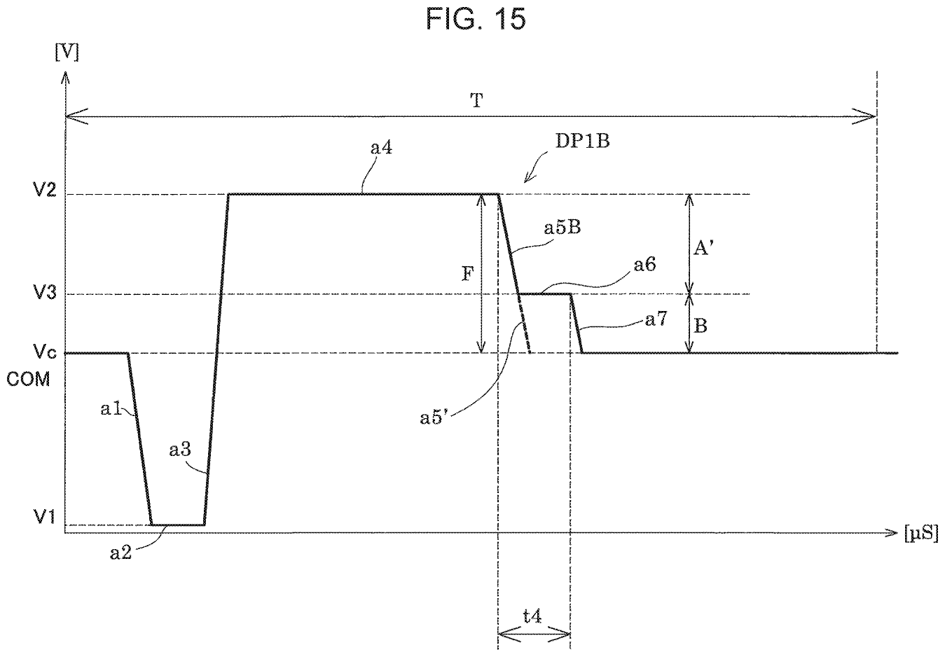

FIG. 15 is a drive waveform illustrating the drive signal COM having a first discharge pulse DP1B of Modification example 2 of Embodiment 1.

As illustrated in FIG. 15, the first discharge pulse DP1B includes the first charge element a1, the first charge potential maintenance element a2, the first contraction element a3, the first potential maintenance element a4, a first damping element a5B, a second potential maintenance element a6, and a re-damping element a7. That is, the first discharge pulse DP1B has two damping elements.

The first charge element a1 to the first potential maintenance element a4 are the same as those in Embodiment 1 described above. The first damping element a5B changes the potential from the second potential V2 to the third potential V3, thereby expanding the pressure chamber 12.

The second potential maintenance element a6 maintains the third potential V3 for a certain period of time.

The re-damping element a7 changes the potential from the third potential V3 to the reference potential Vc, thereby expanding the pressure chamber 12.

Here, the re-damping element a7 starts after 0.5×Tc after the first damping element a5B starts. That is, time t4 between the start point of the first damping element a5 and the start point of the re-damping element a7 is 0.5× Tc.

In this manner, by starting the re-damping element a7 after 0.5×Tc from the start of the first damping element a5B, the vibration of the liquid surface 120 in the nozzle 21, which remains even after being damped by the first damping element a5B, can be canceled by the re-damping element a7. Therefore, the residual vibration of the liquid surface 120 in the nozzle 21 can be further reduced by the re-damping element a7.

Further, as described above, the pressure of the ink inside the pressure chamber 12 when the first damping element a5B of the first discharge pulse DP1 having the time t1 of 2× Tc is supplied, is attenuated by (compared to the discharge pulse DP′ of the comparative example having the time t1 of 1× Tc. As a result, when the potential is continuously changed from the second potential V2 to the reference potential Vc as in the first damping element a5 illustrated in FIG. 4, the pressure fluctuation generated by the driving of the active portion 310 by the first damping element a5 may be too large with respect to the magnitude of the residual vibration. Therefore, by dividing the potential change from the second potential V2 to the reference potential Vc into the first damping element a5B and the re-damping element a7, the potential change amplitude of each of the first damping element a5B and the re-damping element a7 can be reduced, so that the magnitude of the pressure fluctuation generated by the driving of the active portion 310 can be adjusted.

A potential difference A of the sum of the first damping element a5B and the re-damping element a7 is obtained by the following equation (5) using a potential difference F of the first damping element a5 of the discharge pulse DP′ of the comparative example.

$$A = F \times ζ = {Fe}^{- \frac{R}{2 L} Tc} \qquad ( 5 )$$

Further, a surplus vibration component Y is obtained by the following equation (6).

$$Y = F - A = F - F ζ = F ( 1 - ζ ) \qquad ( 6 )$$

When the surplus vibration component Y is divided into a potential difference A′ of the first damping element a5B and a potential difference B of the re-damping element a7, each of the potential difference A′ and the potential difference B is obtained by the following equations (7) and (8).

$${A}^{′} = F ζ + \frac{F ( 1 - ζ )}{2} \qquad ( 7 )$$

$$B = \frac{F ( 1 - ζ )}{2} \qquad ( 8 )$$

As described above, by defining the potential differences A′ and B of the first damping element a5B and the re-damping element a7, the residual vibration of the liquid surface 120 in the nozzle 21 can further be suppressed after the first damping element a5B and the re-damping element a7 are supplied, so that the residual vibration after the ink droplet is discharged does not easily affect the discharge of the ink droplet by the next first discharge pulse DP1A, and the discharge of the next ink droplet can be stably performed as the drive period T can be relatively shortened.

The potential differences A′ and B may be A′>B, may be A′<B, or may be A′=B.

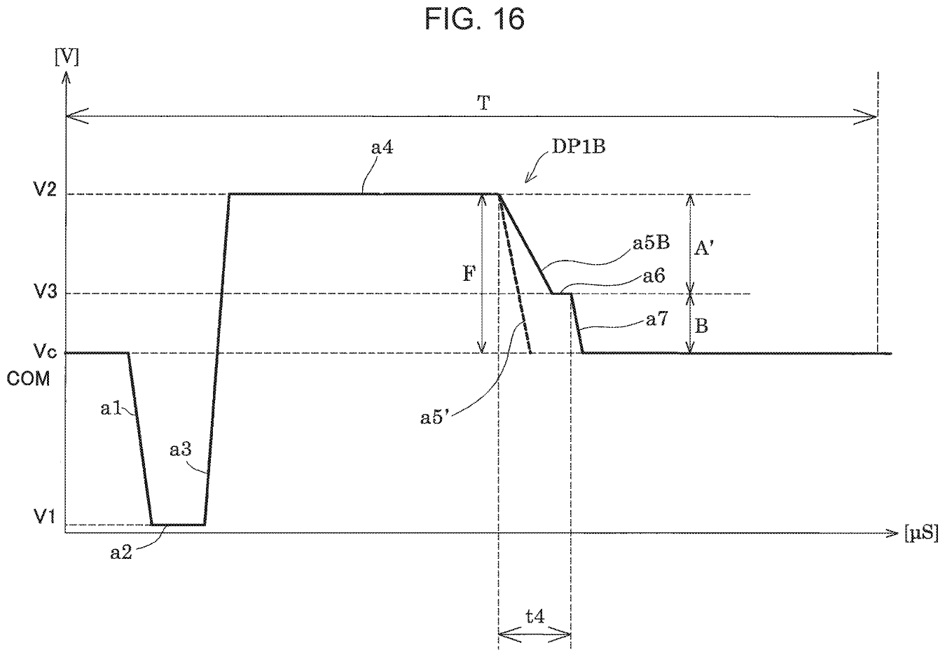

Further, as illustrated in FIG. 16, the potential change rate per unit time of the first damping element a5B is preferably smaller than the potential change rate per unit time of the re-damping element a7. This is because, as described in Modification example 1 above, the magnitude of the pressure fluctuation caused by the driving of the active portion 310 is adapted to the magnitude of the attenuated residual vibration. By making the potential change rate per unit time of the first damping element a5B relatively small, the speed of the satellite droplet 123 can be increased. The potential change rate per unit time of the first damping element a5B may be greater than the potential change rate per unit time of the re-damping element a7.

Further, the application time of the first damping element a5B is preferably shorter than the application time of the re-damping element a7.

Further, the time of the second potential maintenance element a6 may be 0 (zero), that is, the second potential maintenance element a6 may not be provided. That is, the start point of the re-damping element a7 may be the end point of the first damping element a5B.

### Modification Example 3

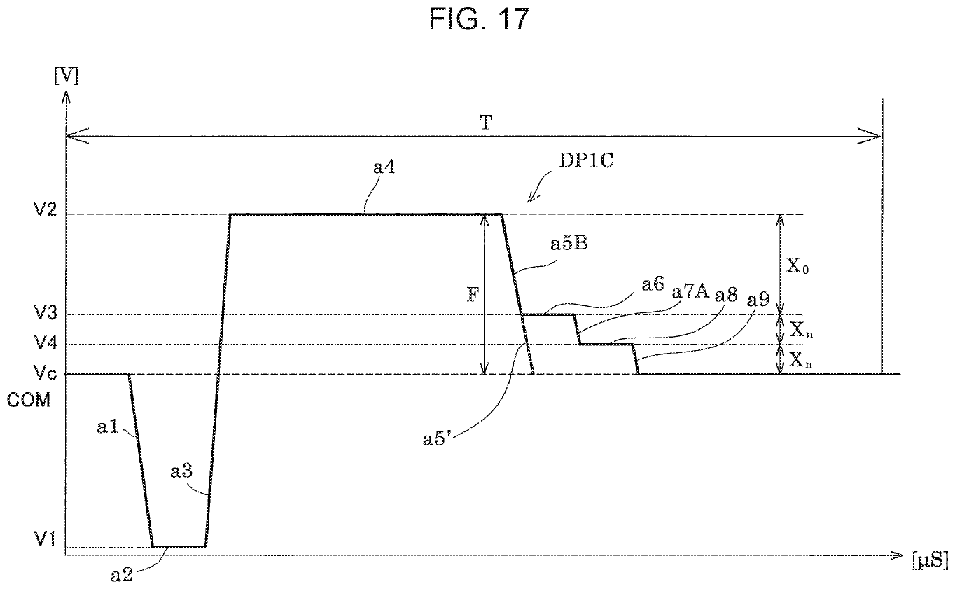

The first discharge pulse DP1 may have a plurality of re-damping elements of two or more. That is, three or more damping elements may be included. Here, FIG. 17 illustrates the drive waveform illustrating the drive signal COM including a first discharge pulse DP1C of Modification example 3 of Embodiment 1.

Modification example 3 is different from Modification example 2 in that the first discharge pulse DP1C includes two re-damping elements after the second potential maintenance element a6. The first charge element a1 to the second potential maintenance element a6 are the same as those described above, and the description thereof will be omitted.

Specifically, as illustrated in FIG. 17, the first discharge pulse DP1C includes a third damping element a7A of the re-damping element, a third potential maintenance element a8, and a fourth damping element a9 of the re-damping element in time series, after the second potential maintenance element a6.

The third damping element a7A changes the potential from the third potential V3 to a fourth potential V4, thereby expanding the pressure chamber 12.

The third potential maintenance element a8 maintains the fourth potential V4 for a certain period of time.

The fourth damping element a9 changes the potential from the fourth potential V4 to the reference potential Vc, thereby expanding the pressure chamber 12.

Although the plurality of re-damping elements of two or more are provided, the same effect as that of Modification example 2 described above is obtained.

Similar to the description of Modification example 2, the potential difference A of the sum between the first damping element a5B, the third damping element a7A, and the fourth damping element a9 is obtained by the above equation (5) using the potential difference F of the first damping element a5′ of the discharge pulse DP′ of the comparative example.

Further, the surplus vibration component Y is obtained by the above equation (6).

Although the configuration in which three damping elements are provided is illustrated in FIG. 17, when an odd number of damping elements are provided, the surplus vibration component Y is divided into the n-th ones (X₁ to Xₙ) other than the first one (X₀). Therefore, the potential of the first one (X₀) is obtained by the following equation (9), and the potential of the n-th one (Xₙ) is obtained by the following equation (10).

$${X}_{0} = F ζ \qquad ( 9 )$$

$${X}_{n} = \frac{F ( 1 - ζ )}{n} \qquad ( 10 )$$

Further, when an even number of the damping elements are provided, the surplus vibration component Y is divided into the number n of the damping elements (X₁ to Xₙ). Therefore, the potential of (X₀) is obtained by the following equation (11), and the n-th (Xₙ) is obtained by the following equation (12).

$${X}_{0} = \frac{F ( 1 - ζ )}{n} \qquad ( 11 )$$

$${X}_{n} = \frac{F ( 1 - ζ )}{n} \qquad ( 12 )$$

As described above, by defining the potential differences X₀ and Xₙ of the plurality of damping elements of three or more, the residual vibration of the liquid surface 120 in the nozzle 21 can further be suppressed after the first damping element a5B, the third damping element a7A, and the fourth damping element a9 are supplied, so that the residual vibration after the ink droplet is discharged does not easily affect the discharge of the ink droplet by the next first discharge pulse DP1C, and the discharge of the next ink droplet can be stably performed as the drive period T can be relatively shortened.

Further, among the three damping elements, that is, the first damping element a5B, the third damping element a7A, and the fourth damping element a9, it is preferable that the potential change rate per unit time of the first damping element a5B, which is the initial damping element, is the largest, and the potential change rate per unit time of the fourth damping element a9, which is the last damping element, is the smallest. This is because, whereas the residual vibration is gradually attenuated and damped to be reduced, when the potential change rate per unit time of the fourth damping element a9, which is the last damping element, is increased, the pressure fluctuation for damping generated by the driving of the active portion 310 becomes excessive with respect to the magnitude of the residual vibration, the excessive pressure fluctuation becomes an increase in the residual vibration, thereby impairing the discharge stability of the continuous ink droplets at a high frequency.

Further, in the present embodiment, the three damping elements are provided in the first discharge pulse DP1C, but the present disclosure is not limited thereto, and four or more damping elements may be provided.

### Embodiment 2

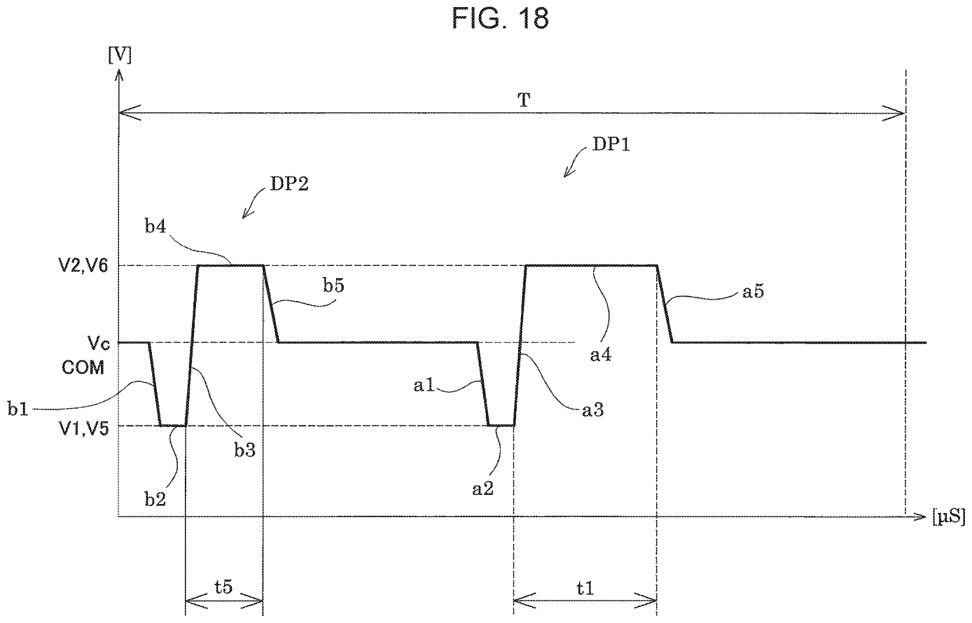

FIG. 18 is a drive waveform illustrating the drive signal COM including the first discharge pulse DP1 according to Embodiment 2 of the present disclosure. Members that are the same as those in the above-described embodiment are denoted by the same reference numerals, and redundant descriptions are omitted.

As illustrated in FIG. 18, the drive signal COM has a second discharge pulse DP2 and the first discharge pulse DP1 in this order in time series in one drive period T. With respect to the first discharge pulse DP1, the same description as in Embodiment 1 described above will not be repeated.

The second discharge pulse DP2 drives the active portion 310 to discharge the ink droplet from the nozzle 21. Specifically, the second discharge pulse DP2 continuously includes a second charge element b1, a second charge potential maintenance element b2, a second contraction element b3, a second potential maintenance element b4, and a second damping element b5 in this order in time series.

The second charge element b1 changes the potential from the reference potential Vc to a fifth potential V5, thereby expanding the volume of the pressure chamber 12 from the reference volume. In the present embodiment, the fifth potential V5 is the same potential as the first potential V1.

The second charge potential maintenance element b2 maintains the fifth potential V5, which is the potential of the end point of the second charge element b1, for a certain period of time.

The second contraction element b3 changes the potential from the fifth potential V5 to a sixth potential V6, thereby causing the volume of the pressure chamber 12 to contract. In the present embodiment, the sixth potential V6 is the same potential as the second potential V2.

The second potential maintenance element b4 maintains the sixth potential V6, which is the potential of the end point of the second contraction element b3, for a certain period of time.

The second damping element b5 changes the potential from the sixth potential V6 to the reference potential Vc, thereby expanding the volume of the pressure chamber 12.

Here, time t5 from the start of the second contraction element b3 to the start of the second damping element b5, that is, the time t5 from the start point of the second contraction element b3 to the start point of the second damping element b5 is set to be greater than or equal to (N−0.25) times and less than or equal to (N+0.25) times the natural vibration period Tc of the pressure chamber 12 (N is a natural number greater than or equal to 1).

The satellite droplet 123 discharged by such a second discharge pulse DP2 has a low speed and is likely to be misted, as described above. However, since the satellite droplet 123 before being misted can be collected by the main droplet 122 of the next first discharge pulse DP1, the misting can be suppressed. Further, by setting the application time t5 to be greater than or equal to (N−0.25) times and less than or equal to (N+0.25) times the natural vibration period Tc (N is a natural number greater than or equal to 1), the vibration of the liquid surface 120 of the nozzle 21 can be damped as described above, and the residual vibration can be suppressed, so that when the ink droplet is discharged by the next first discharge pulse DP1, the influence of the residual vibration can be suppressed. As a result, the discharge stability of the ink droplet of the first discharge pulse DP1, that is, the ink droplet can be discharged with the desired flight speed and weight, and the ink droplet can be discharged by the first discharge pulse DP1 in a short time after the second discharge pulse DP2. As a result, the discharge of continuous ink droplets can be performed at a high frequency.

The drive signal COM may have a plurality of second discharge pulses DP2 within the one drive period T. However, by setting the final discharge pulse as the first discharge pulse DP1, when the final ink droplet is discharged, the misting of the satellite droplets 123 can be suppressed, and the residual vibration can be suppressed.

Further, in the present embodiment, the drive signal COM is assumed to have the first discharge pulse DP1 and the second discharge pulse DP2 in the one drive period T, but the present disclosure is not limited thereto. For example, the drive signal COM may have a plurality of first discharge pulses DP1 in the one drive period T.

### Embodiment 3

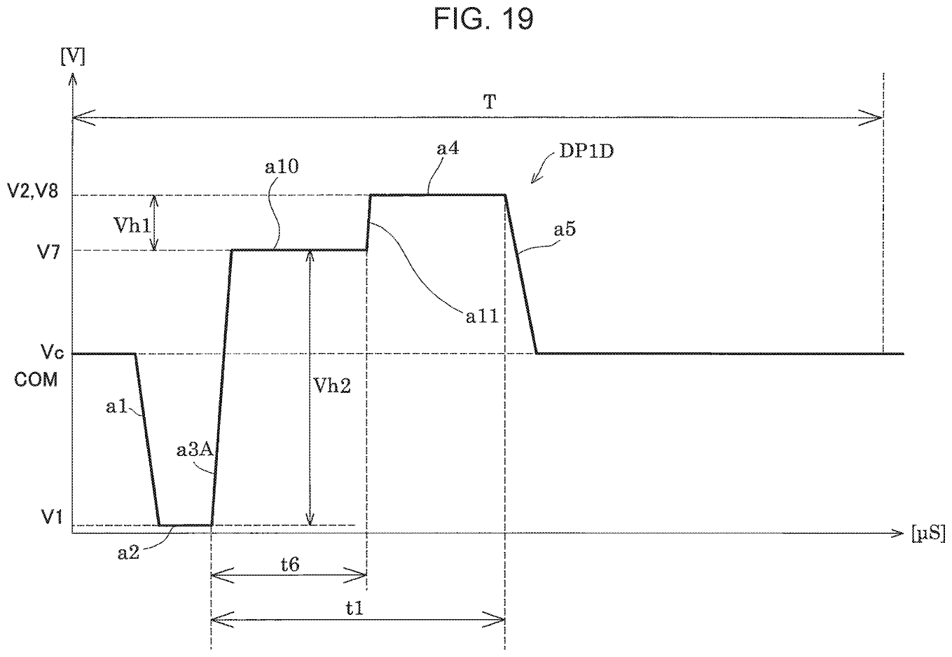

FIG. 19 is a drive waveform illustrating the drive signal COM of Embodiment 3 of the present disclosure. Members that are the same as those in the above-described embodiment are denoted by the same reference numerals, and redundant descriptions are omitted.

As illustrated in FIG. 19, the drive signal COM has a first discharge pulse DP1D. The first discharge pulse DP1D includes the first charge element a1, the first charge potential maintenance element a2, a first contraction element a3A, a fourth potential maintenance element a10, a re-contraction element a11, the first potential maintenance element a4, and the first damping element a5 in this order in time series. That is, the first discharge pulse DP1D is obtained by changing the first contraction element a3 of the first discharge pulse DP1 of Embodiment 1 described above to two contraction elements that are gradually contracted, specifically, the first contraction element a3A and the re-contraction element a11.

Since the first charge element a1 and the first charge potential maintenance element a2 are the same as those in Embodiment 1 described above, the description thereof will be omitted.

The first contraction element a3A of the present embodiment changes the potential from the first potential V1 to a seventh potential V7, thereby causing the pressure chamber 12 to contract. The seventh potential V7 is a potential lower than the second potential V2 described above.

The fourth potential maintenance element a10 maintains the seventh potential V7, which is the potential of the end point of the first contraction element a3A, for a certain period of time. During the supply of the fourth potential maintenance element a10, pressure vibration occurs in the ink in the pressure chamber 12 with the natural vibration period Tc.

The re-contraction element a11 changes the potential from the seventh potential V7 to an eighth potential V8, thereby causing the pressure chamber 12 to contract. In the present embodiment, for example, the eighth potential V8 is the same potential as the second potential V2 of Embodiment 1.

The first potential maintenance element a4 maintains the eighth potential V8, which is the potential of the end point of the re-contraction element a11, or the second potential V2 in the present embodiment, for a certain period of time.

The first damping element a5 changes the potential from the eighth potential V8 to the reference potential Vc, thereby expanding the volume of the pressure chamber 12.

In such a first discharge pulse DP1D, the first contraction element a3A and the fourth potential maintenance element a10 are portions that, by themselves, cause a pressure change in the ink in the pressure chamber 12 to such an extent that the ink droplets are discharged, that is, portions used for discharging the ink droplets. Further, the re-contraction element a11 and the first potential maintenance element a4 are portions that, by themselves, cause a pressure change in the ink in the pressure chamber 12 to such an extent that the ink droplets are not discharged, that is, portions that are not used for discharging the ink droplets. That is, a potential difference Vh1 from the seventh potential V7 to the eighth potential V8 of the re-contraction element a11 is smaller than a potential difference Vh2 from the first potential V1 to the seventh potential V7 of the first contraction element a3A.

In the first discharge pulse DPID, as in Embodiment 1 described above, the time t6 from the start of the first contraction element a3A to the start of the first damping element a5 is greater than or equal to (N+0.75) times and less than or equal to (N+1.25) times the natural vibration period Tc (N is a natural number greater than or equal to 1).

Further, the time from the start of the first contraction element a3A to the start of the re-contraction element a11, that is, time t6 from the start point of the first contraction element a3A to the start point of the re-contraction element a11 is set to be greater than or equal to (N−0.25) times and less than or equal to (N+0.25) times the natural vibration period Tc (N is a natural number greater than or equal to 1), so that the residual vibration generated by the driving of the active portion 310 by the first contraction element a3A and the pressure fluctuation generated by the driving of the active portion 310 by the re-contraction element a11 resonate with each other to further vibrate the liquid surface 120 in the nozzle 21. As the liquid surface 120 in the nozzle 21 is vibrated more greatly, the separation between the ink in the nozzle 21 and the liquid column 121 is accelerated, and the speed of the satellite droplet 123 can be further increased.

The configuration having such a first contraction element a3A and a re-contraction element a11 can also be applied to the discharge pulses of Embodiment 1, Modification example 1, Modification example 2, and Embodiment 2 described above.

### OTHER EMBODIMENTS

Although each embodiment of the present disclosure is described above, the basic configuration of the present disclosure is not limited to the above.

For example, the discharge pulse of each of the above-described embodiments and modification examples may further include a re-damping element that causes the pressure chamber 12 to contract after the damping element, thereby reducing the residual vibration in the pressure chamber 12.

Further, in each of the embodiments described above, the thin-film piezoelectric element 300 is used as the drive element to generate pressure changes in the pressure chamber 12, but the present disclosure is not particularly limited thereto, and as the drive element, for example, a thick-film piezoelectric actuator formed by methods such as attaching a green sheet, or a longitudinal vibration type piezoelectric actuator that expands and contracts in the axial direction by alternately stacking a piezoelectric material and an electrode forming material, can be used. Further, as the drive element, a so-called electrostatic actuator that deforms a vibration plate by an electrostatic force to eject droplets from the nozzle 21, or the like can be used.

Furthermore, the present disclosure broadly targets a11 liquid ejecting apparatuses including a liquid ejecting head. The liquid ejecting head includes, for example, recording heads such as various ink jet recording heads used in image recording apparatuses such as printers, and color material ejecting heads used in manufacturing color filters such as liquid crystal displays. Further, the liquid ejecting head includes, for example, electrode material ejecting heads used for forming electrodes of organic EL displays, field emission display (FED), or the like, and biomaterial ejecting heads used for manufacturing biochips, or the like, and the present disclosure can also be applied to liquid ejecting apparatuses equipped with these liquid ejecting heads and a driving method thereof.

### Addendum

From the examples illustrated above, for example, the following configurations can be understood.

According to Aspect 1, which is a preferred aspect, there is provided a liquid ejecting apparatus including a discharge portion that includes a nozzle discharging liquid, a pressure chamber communicating with the nozzle, and a piezoelectric element that is configured to displace to cause a pressure fluctuation in the liquid in the pressure chamber according to a supplied drive signal, and a drive circuit that is configured to generate the drive signal, in which the drive signal has a first discharge pulse that changes a potential to cause a droplet to be discharged from the nozzle, and the first discharge pulse has a first contraction element that changes the potential to cause the pressure chamber to contract, thereby the potential change causing the liquid to protrude from the nozzle, and a first damping element that changes the potential to cause the pressure chamber to expand, and the first damping element starts changing the potential within a period commencing at a start of the first contraction element and being greater than or equal to (N+0.75) times and less than or equal to (N+1.25) times a natural vibration period of the discharge portion (N is a natural number greater than or equal to 1).

Accordingly, the speed of the satellite droplet separated from the main droplet can be increased, and the satellite droplet can be landed on the medium without misting the satellite droplet. As a result, the printing quality can be improved because the target dot can be formed by landing a sufficient amount of ink on the medium. Further, the residual vibration of the liquid surface in the nozzle after the droplet is discharged can be suppressed, and the remaining residual vibration is unlikely to affect the discharge of the next droplet, so that the stable continuous discharge of the droplets can be performed as the continuous discharge of the droplets can be performed at a high frequency.

In Aspect 2, which is a specific example of Aspect 1, the first discharge pulse has a first potential maintenance element that maintains a potential of an end point of the first contraction element from the end point of the first contraction element to a start point of the first damping element. Accordingly, by not driving the piezoelectric element between the end point of the first contraction element and the start point of the first damping element, the liquid column in the nozzle can be prevented from vibrating in the direction of being pulled to a side of the pressure chamber. As a result, by suppressing an increase in the time it takes for the satellite droplet to be separated from the main droplet, a decrease in the speed of the satellite droplets can be suppressed.

In Aspect 3, which is a specific example of Aspect 1, the first discharge pulse has a re-contraction element that further causes the pressure chamber to contract after the first contraction element. Accordingly, the time it takes for the satellite droplet to be separated from the main droplet can be shortened by the re-contraction element, and the speed of the satellite droplet can be increased.

In Aspect 4, which is a specific example of Aspect 1, the drive signal has a second discharge pulse that changes the potential to cause a droplet to be discharged from the nozzle before the first discharge pulse, and the second discharge pulse has a second contraction element that changes the potential to cause the pressure chamber to contract, thereby the potential change causing the liquid to protrude from the nozzle, and a second damping element that starts changing the potential to be greater than or equal to (N−0.25) times and less than or equal to (N+0.25) times the natural vibration period of the discharge portion (N is a natural number greater than or equal to 1) from a start of the second contraction element to expand the pressure chamber. The satellite droplet generated by the second discharge pulse is easily misted, but can be collected by the first discharge pulse, so that the deterioration of the printing quality can be suppressed. Further, by defining the time from the start of the second contraction element of the second discharge pulse to the start of the second damping element as described above, the discharge of the continuous droplets can be performed at a high frequency by suppressing an increase in the time of the first discharge pulse.

In Aspect 5, which is a specific example of Aspect 1, a potential difference of the first damping element is greater than or equal to 10% and less than or equal to 80% of a potential difference of the first contraction element. Accordingly, the residual vibration can be effectively suppressed by the first damping element.

In Aspect 6, which is a specific example of Aspect 1, the first discharge pulse has a re-damping element that further expands the pressure chamber after the first damping element. Accordingly, the vibration of the liquid surface in the nozzle generated by the first damping element can be canceled by the re-damping element. Therefore, the residual vibration of the liquid surface in the nozzle after the droplet discharge can be further reduced.

In Aspect 7, which is a specific example of Aspect 6, a potential change rate per unit time of the first damping element is smaller than a potential change rate per unit time of the re-damping element. Accordingly, by making the potential change rate per unit time of the first damping element relatively small, the speed of the satellite droplet can be increased. Further, by making the potential change rate per unit time of the re-damping element relatively large, the residual vibration after the ink droplet is discharged can be effectively suppressed.

In Aspect 8, which is a specific example of Aspect 6, an application time of the first damping element is shorter than an application time of the re-damping element.

In Aspect 9, which is a specific example of Aspect 6, the first discharge pulse has a second potential maintenance element that maintains a potential of an end point of the first damping element from the end point of the first damping element to a start point of the re-damping element.

In Aspect 10, which is a specific example of Aspect 6, the first discharge pulse has a plurality of the re-damping elements. Accordingly, the vibration of the liquid surface in the nozzle generated by the first damping element can be canceled by the plurality of re-damping elements, so that the residual vibration of the liquid surface in the nozzle after the droplet is discharged can be further reduced.

In Aspect 11, which is a specific example of Aspect 10, the first damping element has a highest potential change rate per unit time among the first damping element and the plurality of re-damping elements, and a last re-damping element has a lowest potential change rate per unit time among the first damping element and the plurality of re-damping elements. Accordingly, since the residual vibration is gradually attenuated and damped to be reduced, the pressure vibration for damping can be suppressed from being excessive with respect to the residual vibration, and the high frequency discharge stability of the continuous droplets can be improved.

According to Aspect 12, which is a preferred aspect, there is provided a driving method of a liquid ejecting apparatus including a discharge portion that includes a nozzle discharging liquid, a pressure chamber communicating with the nozzle, and a piezoelectric element that is configured to displace to cause a pressure fluctuation in the liquid in the pressure chamber according to a supplied drive signal, and a drive circuit that is configured to generate the drive signal, the method including supplying the drive signal which has a first discharge pulse having a first contraction element that changes a potential to cause the pressure chamber to contract, thereby the potential change causing the liquid to protrude from the nozzle, and a first damping element that changes the potential to cause the pressure chamber to expand, and the first damping element starts changing the potential within a period commencing at a start of the first contraction element and being greater than or equal to (N+0.75) times and less than or equal to (N+1.25) times a natural vibration period of the discharge portion (N is a natural number greater than or equal to 1), to the piezoelectric element to cause a droplet to be discharged from the nozzle.

Accordingly, the speed of the satellite droplet separated from the main droplet can be increased, and the satellite droplet can be landed on the medium without misting the satellite droplet. As a result, the printing quality can be improved because the target dot can be formed by landing a sufficient amount of ink on the medium. Further, the residual vibration of the liquid surface in the nozzle after the droplet is discharged can be suppressed, and the remaining residual vibration is unlikely to affect the discharge of the next droplet, so that the stable continuous discharge of the droplets can be performed as the continuous discharge of the droplets can be performed at a high frequency.

What is claimed is:

1. A liquid ejecting apparatus comprising:
a discharge portion that includes a nozzle discharging liquid, a pressure chamber communicating with the nozzle, and a piezoelectric element that is configured to displace to cause a pressure fluctuation in the liquid in the pressure chamber according to a supplied drive signal; and
a drive circuit that is configured to generate the drive signal, wherein
the drive signal has a first discharge pulse that changes a potential to cause a droplet to be discharged from the nozzle, and
the first discharge pulse has
a first contraction element that changes the potential to cause the pressure chamber to contract so as to protrude the liquid from the nozzle, and
a first damping element that changes the potential to cause the pressure chamber to expand, and the first damping element starts changing the potential within a period commencing at a start of the first contraction element and being greater than or equal to (N+0.75) times and less than or equal to (N+1.25) times a natural vibration period of the discharge portion (N is a natural number greater than or equal to 1).

2. The liquid ejecting apparatus according to claim 1, wherein
the first discharge pulse has a first potential maintenance element that maintains a potential of an end point of the first contraction element from the end point of the first contraction element to a start point of the first damping element.

3. The liquid ejecting apparatus according to claim 1, wherein
the first discharge pulse has a re-contraction element that further causes the pressure chamber to contract after the first contraction element.

4. The liquid ejecting apparatus according to claim 1, wherein
the drive signal has a second discharge pulse that changes the potential to cause a droplet to be discharged from the nozzle before the first discharge pulse, and
the second discharge pulse has
a second contraction element that changes the potential to cause the pressure chamber to contract so as to protrude the liquid from the nozzle, and
a second damping element that starts changing the potential to be greater than or equal to (N−0.25) times and less than or equal to (N+0.25) times the natural vibration period of the discharge portion (N is a natural number greater than or equal to 1) from a start of the second contraction element to expand the pressure chamber.

5. The liquid ejecting apparatus according to claim 1, wherein
a potential difference of the first damping element is greater than or equal to 10% and less than or equal to 80% of a potential difference of the first contraction element.

6. The liquid ejecting apparatus according to claim 1, wherein
the first discharge pulse
has a re-damping element that further expands the pressure chamber after the first damping element.

7. The liquid ejecting apparatus according to claim 6, wherein
a potential change rate per unit time of the first damping element is smaller than a potential change rate per unit time of the re-damping element.

8. The liquid ejecting apparatus according to claim 6, wherein
an application time of the first damping element is shorter than an application time of the re-damping element.

9. The liquid ejecting apparatus according to claim 6, wherein
the first discharge pulse has a second potential maintenance element that maintains a potential of an end point of the first damping element from the end point of the first damping element to a start point of the re-damping element.

10. The liquid ejecting apparatus according to claim 6, wherein
the first discharge pulse has a plurality of the re-damping elements.

11. The liquid ejecting apparatus according to claim 10, wherein
the first damping element has a highest potential change rate per unit time among the first damping element and the plurality of re-damping elements, and
a last re-damping element has a lowest potential change rate per unit time among the first damping element and the plurality of re-damping elements.

12. A driving method of a liquid ejecting apparatus including a discharge portion that includes a nozzle discharging liquid, a pressure chamber communicating with the nozzle, and a piezoelectric element that is configured to displace to cause a pressure fluctuation in the liquid in the pressure chamber according to a supplied drive signal, and a drive circuit that is configured to generate the drive signal, the method comprising:
supplying the drive signal which has a first discharge pulse having
a first contraction element that changes a potential to cause the pressure chamber to contract so as to protrude the liquid from the nozzle, and
a first damping element that changes the potential to cause the pressure chamber to expand, and the first damping element starts changing the potential within a period commencing at a start of the first contraction element and being greater than or equal to (N+0.75) times and less than or equal to (N+1.25) times a natural vibration period of the discharge portion (N is a natural number greater than or equal to 1),
to the piezoelectric element to cause a droplet to be discharged from the nozzle.
